(19) United States
(12) Patent Application Publication
(10) Pub. No.: US 2003/0014951 A1
(43) Pub. Date: Jan. 23, 2003

(54) Horizontal separator tank for oil-flooded air compressor

(75) Inventor: John Crouse, Mooresville, NC (US)

Correspondence Address: Glenn M. Massina, Michael Best & Friedrich LLP, Suite 360, 3773 Corporate Parkway, Center Valley, PA, 18034, US

(73) Assignee: Ingersoll-Rand Company, Woodcliff Lake, NJ (US)

(21) Appl. No.: 10/198,576

(22) Filed: Jul. 18, 2002

Related U.S. Application Data
(60) Provisional application No. 60/306,648, filed on Jul. 20, 2001.

(51) Int. Cl. B01D 46/00

(52) U.S. Cl. 55/322; 55/482

(57) ABSTRACT

A separator tank assembly for use in conjunction with an oil-filled air compressor. The separator tank assembly comprises a tubular tank having opposed first and second ends and opposed upper and lower surfaces. The opposed ends are spaced a substantially greater distance from one another than the opposed upper and lower surfaces. An airend inlet port extends through the upper surface adjacent the first tank end and includes an internal outlet directed toward the first tank end. An air exit port extends through the upper surface adjacent the second tank end. Oil collects in a lower portion of the tank chamber and exits through an oil exit port extending through the tank lower surface.

### BACKGROUND

In conventional air compressor systems, air is compressed in a compression chamber or airend of a compressor, for example, by a set of rotary screws, and a lubricant, such as oil, is injected into the compression chamber and mixes with the compressed air. The oil is generally injected into the compression chamber for a number of reasons including cooling the air compressor system, lubricating bearings, balancing axial forces and sealing the rotary screws. The oil is preferably removed from the stream of compressed air before the compressed air is used downstream for pneumatic equipment and/or other tools.

In such conventional air compressor systems, the compressed air and oil mixture discharged from the airend of the compressor flows with a high velocity into a separator tank where the air and oil of the air/oil mixture are caused to separate. The separator tank is usually cylindrical and the air/oil mixture is directed around an inner wall of a separation chamber. The tanks are generally tall and narrow, i.e., having a height substantially greater than the width, such that the air/oil mixture can easily be directed at the inner wall for repeated circulation. Additionally, the tall configuration is provided to maximize the contact surface on the inner wall as the air/oil mixture moves up the chamber in a circular manner.

The combination of the centrifugal forces acting on the air/oil mixture and contact between the air/oil mixture and the inner wall of the separation chamber causes much of the oil to separate from the air/oil mixture, thereby allowing gravity to draw most of the oil downwardly into a lower portion of the separation chamber and also allowing the air to separate from the oil and flow upwardly into an upper portion of the separation chamber to achieve primary separation.

### SUMMARY

The present invention provides a separator tank assembly, preferably for use in conjunction with an oil-filled air compressor, having a horizontal configuration. The separator tank assembly comprises a tubular tank having opposed first and second ends and opposed upper and lower surfaces. The opposed ends are spaced a substantially greater distance from one another than the opposed upper and lower surfaces. An airend inlet port extends through the upper surface adjacent the first tank end, the airend inlet port having an external inlet and an internal outlet directed toward the first tank end. An air exit port extends through the upper surface adjacent the second tank end. The lower surface of the tank defines an oil sump where oil collects and exits through an oil exit port extending through the lower surface. In a preferred embodiment of the invention, at least one solid baffle is positioned in the oil sump area to reduce turbulence in the collected oil.

### BRIEF DESCRIPTION OF THE DRAWINGS

FIG. 1 is an isometric view of a preferred separator tank of the present invention.

FIG. 2 is a section view taken along the line 2-2 in FIG. 1.

FIG. 3 is a front elevation view of a porous retainer plate used in a preferred embodiment of the present invention.

FIG. 4 is a section view taken along the line 4-4 in FIG. 2.

FIG. 5 is a front elevation view of a solid baffle used in a preferred embodiment of the present invention.

FIG. 6 is a section view taken along the line 6-6 in FIG. 2.

FIG. 7 is a section view of the separator tank assembly as shown in FIG. 2 illustrating the air/oil flow paths.

### DETAILED DESCRIPTION OF THE PREFERRED EMBODIMENTS

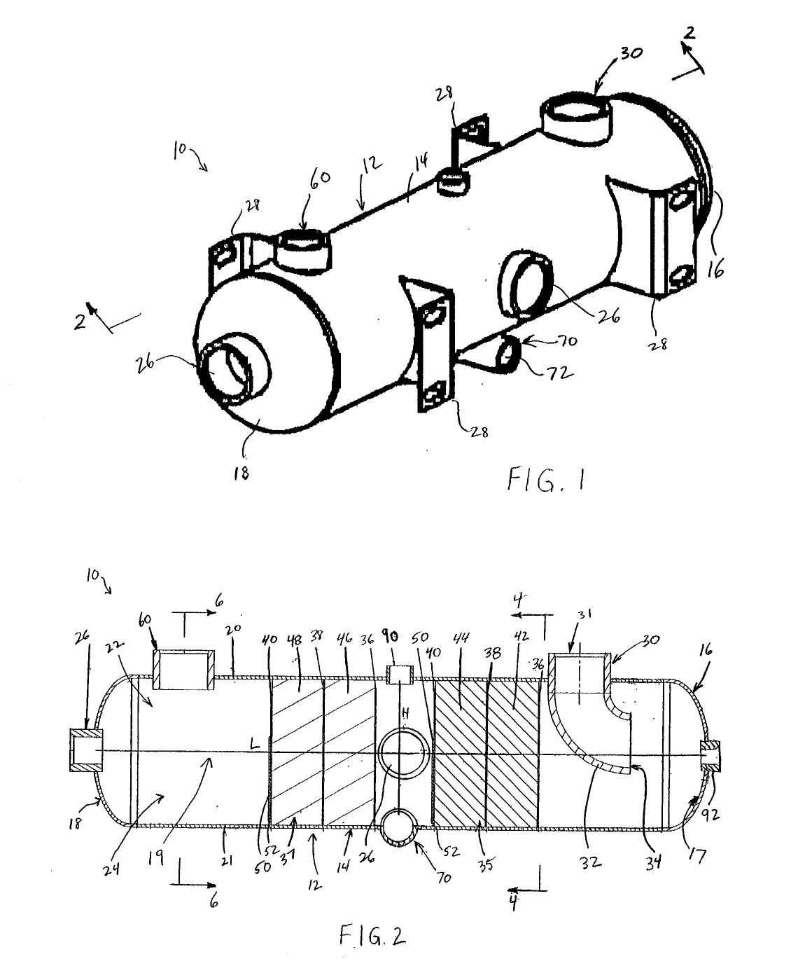

Referring to FIGS. 1 and 2, a separator tank assembly 10 that is a preferred embodiment of the present invention is shown. The tank assembly 10 generally comprises a substantially enclosed tank 12 defined by a tube 14 with opposed ends 16 and 18. The tube 14 preferably has a circular cross section, but may have other shapes, for example, square or elliptical. The tank 12 has upper and lower surfaces 20 and 21 defining an internal chamber 19 having an upper portion 22 and a lower portion 24. The tank 12 has a horizontal configuration such that the flow through the tank is generally axial as opposed to the circular flow of the prior art systems. In the preferred embodiment of the present invention, the length L between the ends 16 and 18 is substantially greater than the height H between the upper and lower surfaces 20 and 21. The length L is generally one and one half or more times the height H, with a preferred length L approximately four times the height H. For example, the tank 12 of a preferred embodiment of the invention has a height H of 6 inches and a length L of 24 inches.

Mounting brackets 28 or the like are provided along the tank 12 for securing the tank assembly 10 in a desired air compressor system (not shown). One or more oil sight glasses 26 are provided through the ends 16, 18 or surfaces 20, 21 of the tank 12 to permit monitoring of the oil level in the tank. A pressure relief port 90 and a high temperature switch 92 are also provided. The pressure relief port 90 allows pressure to be released in the event the tank pressure becomes greater than a desired level. The temperature switch 92 is configured to shut off the compressor if the compressor discharge temperature exceeds the switch limit.

An airend inlet port 30 extends through the upper surface 20 into the upper portion 22 of the chamber 19 adjacent the first end 16 of the tank 12. The airend inlet port 30 has an inlet opening 31 that is connected in communication with the compressor airend outlet (not shown). The inlet port 30 has an internal bend 32 having an outlet opening 34 directed toward the internal surface 17 of the end 16. In the preferred embodiment, the inlet opening 31 is parallel to the tank upper surface 20 with the bend 32 having a ninety degree turn toward the end internal surface 17. However, other configurations may be utilized, for example, the inlet port 30 may be a straight tube extending through the upper surface 20 at an angle such that the outlet 34 is directed toward the end wall internal surface 17. As explained in further detail below, the pressurized air/oil mixture from the compressor airend enters through the inlet 31 and is blasted out of the outlet 34 against the proximate end wall internal surface 17.

An air outlet port 60 extends through the upper surface 20 into the chamber upper portion 22 adjacent the second end 18 of the tank 12. The air outlet port 60 is connected in communication with a desired pneumatic tool or the like (not shown), either directly or with one or more secondary separation units (not shown) therebetween. A valve or the like (not shown), for example, a minimum pressure check valve, can be provided at the air outlet port 60 to control flow therethrough. The air/oil mixture entering through the inlet port 30 must therefore turn 180 degrees to travel axially down the length of the chamber 19 toward the air outlet port 60. To facilitate the turn, the end wall internal surface 17 is preferably concave. The rapid turn causes some of the oil to separate from the air/oil mixture, however, further separation is generally desired. As such, one or more filtering mediums 35, 37 extend across the chamber 19 from the upper surface 20 to the lower surface 21.

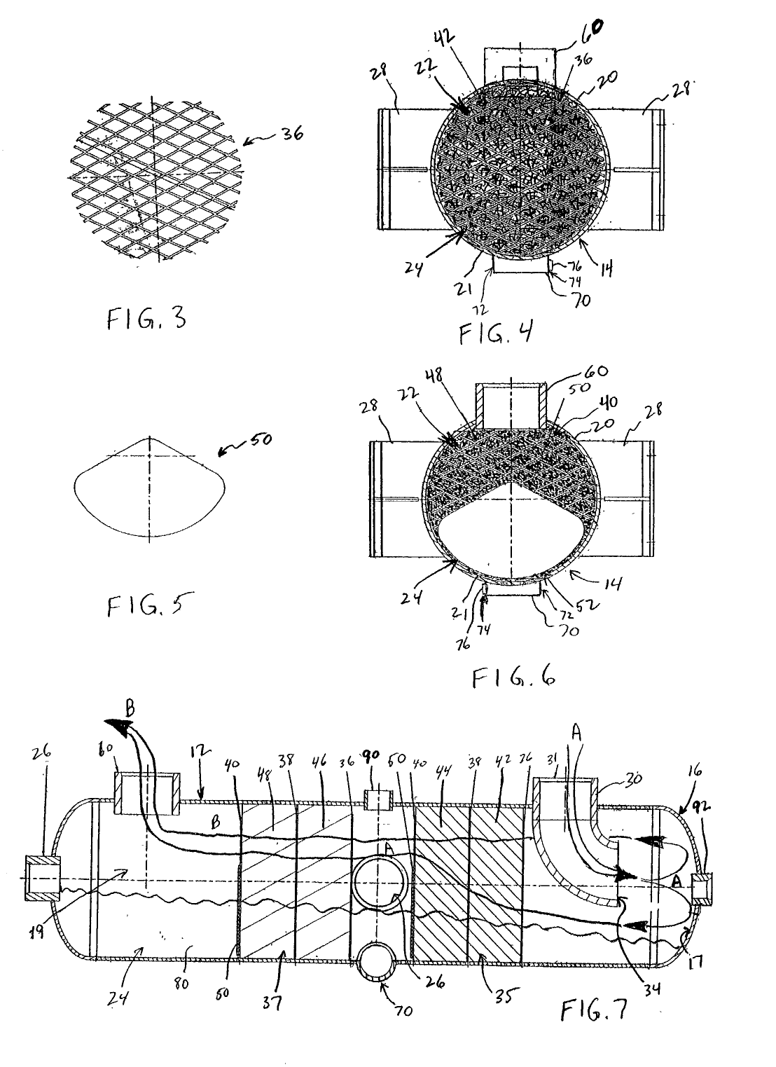

In the preferred embodiment, a coarse filter medium 35 is positioned proximate the first end 16 of the tank 12. The coarse filter medium 35 comprises a pair of coarse filter pads 42 and 44 supported between three porous retainer plates 36, 38, 40. Each of the retainer plates 36, 38, 40 is the same, with retainer plate 36 illustrated in FIG. 3. The preferred retainer plate 36 is a lattice structure which provides some filtering of the oil, but generally allows the air/oil mixture to pass through. Other retaining structures, for example, straps or a holed plate, may also be used. The plates 36, 38, 40 are secured to the inside surface of the tank 12, for example, via tack welding, to hold the coarse filter pads 42 and 44 in place. The coarse filter pads 42 and 44 can be various filtering material, in pad form or otherwise. An example material is a stainless steel mesh material having a wire diameter of approximately 0.011 inch diameter. Again, other materials, of varying coarseness, can also be utilized. The coarse filter medium 35 generally separates large oil droplets from the air/oil mixture.

The fine filter medium 37 is downstream from the coarse filter medium 35. The fine filter medium 37 comprises a pair of fine filter pads 46 and 48 supported between three porous retainer plates 36, 38, 40 as with the coarse filter medium 35. Again, the filter pads 46 and 48 can be various filtering material, in pad form or otherwise. An example material is a stainless steel mesh material having a wire diameter of approximately 0.006 inch diameter. Again, other materials, of varying coarseness, can also be utilized. The fine filter medium 37 generally separates the remaining finer oil droplets from the air/oil mixture leaving a substantially cleaned, pressurized air flow exiting the fine filter medium 37. While two filter mediums 35, 37 have been described, fewer or more filter mediums may be utilized. Additionally, the filter mediums may have different configurations, including fewer or more filter layers, the layers being of the same or different material. For example, a single filter medium (not shown) having one coarse pad and one fine pad may be utilized.

Referring to FIG. 7, the oil 80 that is separated as a result of the impact with the end wall 16 and passage through the filter mediums 35 and 37 drains downward due to gravity where it collects in a sump defined by the lower chamber portion 24. An oil exit port 70 extends from the tank lower surface 21. The oil exit port 70 is preferably a bi-directional port, with one end being the standard oil exit 72 that is connected in communication with downstream components of the air compressor system, for example, an oil cooler or filter. Desired valves of fittings (not shown) are provided at the oil exit 72 to control flow therethrough. The opposite end of the port 70 is a drain opening 74 with a corresponding removable plug 76 (See FIGS. 4 and 6). The drain opening 74 allows an operator to perform an oil change without having to disconnect the separator tank assembly 10 from the compressor assembly. The bi-directional, tangential configuration of the port 70 also provides a shallow profile to reduce the overall clearance necessary for the separator tank assembly 10.

Two solid baffles 50 are provided within the lower chamber portion 24 to help direct the flow of the air/oil mixture to the upper chamber portion 22 of the tank 12, thereby reducing the turbulence in the lower chamber portion 24 where the oil is collected. An illustrative solid baffle 50 is shown in FIG. 5. The baffle 50 has a configuration that complements that of the lower chamber portion 24. Referring to FIGS. 2 and 6, a baffle 50 is preferably attached to each third retainer plate 40, for example via welding, however, more or fewer baffles 50 may be provided and may be connected with other means. The baffles 50 are connected such that there is a gap 52 between the baffle 50 and the lower tank surface 21 to allow settled oil 80 to flow past the baffle 50 toward the oil outlet port 70.

Referring to FIG. 7, flow through the separator tank assembly 10 will be described. The compressed air/oil mixture A enters the tank 12 through the opening 31 of the inlet port 30. The outlet 34 directs the mixture A against the end wall internal surface 17. The mixture then turns 180 degrees to travel axially down the length of the chamber 19. The mixture A next encounters the coarse filter medium 35. A large amount of oil separates and drains to the lower chamber portion 24. As the mixture A exits, the baffle 50 directs the flow of the air/oil mixture A up away from the lower chamber portion 24 of the tank 12 to minimize turbulence in this area where the oil 80 leaves the tank to travel to the oil cooler or the like. The air/oil mixture A continues axially down the tank, where it encounters the fine filter medium 37. Remaining oil 80 is filtered from the mixture A, leaving a substantially clean pressurized air flow B. The baffle 50 at the end of the fine filter medium directs the clean air flow B toward the top half of the tank, reducing the turbulence in the collected oil. With much of the oil 80 separated by the passage through the tank 12, the cleaned air flow B exits the tank 12 through the air outlet port 60 to its intended application, for example, a pneumatic tool, either directly or after passing through one or more secondary separator units. Oil 80 collected in the tank 12 exits through the oil exit 72 of the outlet port 70 and is recirculated into the air compressor system.

What is claimed is:

1. A separator tank assembly comprising:
a tubular tank having opposed first and second ends and opposed upper and lower surfaces, the opposed ends being spaced a substantially greater distance from one another than the opposed upper and lower surfaces;
an airend inlet port entering through the upper surface adjacent the first tank end, the airend inlet port having an external inlet and an internal outlet directed toward the first tank end;
an air exit port exiting the second tank end adjacent the upper surface; and
an oil exit port exiting through the lower surface between the tank ends.

2. The separator tank assembly of claim 1 wherein the opposed ends are spaced a distance L, the opposed upper and lower surfaces are spaced a distance H and the ratio of L to H is at least 1.5 to 1.

3. The separator tank assembly of claim 2 wherein the ratio of L to H is at least 4 to 1.

4. The separator tank assembly of claim 1 wherein a flow exiting the inlet port outlet is directed substantially perpendicular to the tank first end.

5. The separator tank assembly of claim 1 wherein the inlet port external inlet is substantially parallel to the tank upper surface and the inlet port internal outlet is substantially perpendicular to the external inlet.

6. The separator tank assembly of claim 1 wherein the first tank end has a concave internal surface.

7. The separator tank assembly of claim 1 further comprising at least one filter medium extending between the upper-and lower surfaces and positioned between the airend inlet port and the air exit port.

8. The separator tank assembly of claim 7 wherein a first filter medium is positioned proximate the first tank end and a second filter medium is positioned proximate the second tank end.

9. The separator tank assembly of claim 8 wherein the first filter medium is more coarse than the second filter medium.

10. The separator tank assembly of claim 7 wherein the filter medium comprises filter material positioned between at least two porous retainer plates.

11. The separator tank assembly of claim 10 wherein the filter material includes stainless steel mesh.

12. The separator tank assembly of claim 1 wherein the oil port includes two outlets.

13. The separator tank assembly of claim 12 wherein each oil port outlet extends substantially parallel to the tank lower surface.

14. The separator tank assembly of claim 1 wherein at least one solid baffle extends across the tank between the tank ends adjacent the lower surface.

15. A separator tank assembly comprising:
a generally closed tubular tank having upper and lower portions, each portion having a length and a height with the length of each portion being substantially greater than the height, the lower portion defining an oil sump;
an airend inlet port entering through the upper portion;
an air exit port exiting through the upper portion; and
an oil exit port exiting out of the lower portion.

16. The separator tank assembly of claim 15 wherein the length of each portion is at least 3 times the height of that portion.

17. The separator tank assembly of claim 15 wherein the length of each portion is at least 8 times the height of that portion.

18. The separator tank assembly of claim 15 wherein the tank has a first end adjacent the inlet port and a flow passing through the inlet port is directed substantially perpendicular to the tank first end.

19. The separator tank assembly of claim 18 wherein the first tank end has a concave internal surface.

20. The separator tank assembly of claim 15 further comprising at least one filter medium extending between the upper and lower portions and positioned between the airend inlet port and the air exit port.

21. The separator tank assembly of claim 20 wherein a first filter medium is positioned proximate the first tank end and a second filter medium is positioned downstream from the first filter medium.

22. The separator tank assembly of claim 21 wherein the first filter medium is more coarse than the second filter medium.

23. The separator tank assembly of claim 20 wherein the filter medium comprises filter material positioned between at least two porous retainer plates.

24. The separator tank assembly of claim 23 wherein the filter material includes stainless steel mesh.

25. The separator tank assembly of claim 15 wherein the oil exit port includes two outlets.

26. The separator tank assembly of claim 25 wherein each oil port outlet extends substantially parallel to an external surface of the tank lower portion.

27. The separator tank assembly of claim 15 wherein at least one solid baffle extends across the tank lower portion.
